(19) United States
(12) Patent Application Publication
(10) Pub. No.: US 2011/0053122 A1
(43) Pub. Date: Mar. 3, 2011

(54) NUTRITIONAL ANALYSIS SYSTEM AND METHOD

(75) Inventors: Nicholas J. Hill, Scarborough, ME (US); Kristopher K. Hill, Ipswich, MA (US)

(73) Assignee: Wellness Foundations, LLC, Scarborough, ME (US)

(21) Appl. No.: 12/791,399

(22) Filed: Jun. 1, 2010

Related U.S. Application Data
(60) Provisional application No. 61/182,370, filed on May 29, 2009.

(51) Int. Cl. G09B 19/00

(52) U.S. Cl. 434/127

(57) ABSTRACT

A system and method for analyzing food and liquid consumed by a human subject based on factors such as, but not limited to, age, gender, physical activity level, height and weight to obtain the sum of food's nutritive values and comparing that data to optimal levels, generating a report based on the comparison and allowing the subject to generate reports based on modified, proposed nutrient intakes, the reports showing possible outcomes resulting from altering the diet for the better.

### CROSS-REFERENCE TO RELATED APPLICATIONS

This application claims priority from U.S. provisional patent application No. 61/182,370 titled “Health Monitoring System”, filed on May 29, 2009 and incorporated fully herein by reference.

### TECHNICAL FIELD

The present invention relates to a system and method for tracking the detailed nutritional values of the foods that a subject eats over a period of time and more particularly, to a system and method for analyzing and reporting those nutritional values and predicting possible or probable future health outcomes for the subject based upon nutritional intake and factors such as, but not limited to, gender, age, physical activity level, height and weight.

### BACKGROUND INFORMATION

Many people would like an easy way to track their intake of the daily needs for various nutritional items such as amino acids, antioxidants, carbohydrates, fats, phytonutrients, proteins, minerals and vitamins consumed during a day or during another time period, in order to determine if their food intake is nutritionally adequate to maintain good health or whether it may lead to future degenerative disease. Because a full description of the detailed nutritional values of food intake is not easy to find in one place and to analyze, there is no simple way for individuals to determine this information. In cases where nutritional information is made available, it is not convenient to convert the nutritional information associated with the sum of individual food intake amounts of nutrients such as amino acids, antioxidants, carbohydrates, fats, phytonutrients, proteins, minerals and vitamins from foods eaten based on the number of calories or number of grams of individual nutrients ingested etc., as indicated by, but not limited to, the USDA Daily Recommended Intake (DRI) and other informed sources such medical professionals and research institutions and furthermore, it is not at all simple to make an analysis of the food over time and to recommend how to improve one's health outlook based on possible changes to one's food intake according to various other factors such as the individual's gender, age, physical activity level, height and weight.

Accordingly, what is needed is a system and method for tracking the detailed nutritional values of foods eaten by a subject for the purpose of evaluating and improving the potential health outcome for that human subject by allowing him or her to make better informed nutritional choices in connection with various other factors such as the individual's gender, age, physical activity level, height and weight.

### SUMMARY

The present invention includes a novel nutritional analysis system and method designed to assist a user based on various factors such as, but not limited to, age, gender, physical activity level, height and weight in understanding possible or probable health outcomes based on the detailed nutritional values of the foods they are eating or might eat.

According to one aspect of the present invention, a user inputs various factors such as, for example, age, gender, physical activity, height and weight level along with lists of foods consumed into a database. The amount of food, by weight, volume or other pertinent description is recorded and stored in the database. The food consumed over a period of time is analyzed and detailed nutrient values are summed where appropriate, and such values are compared to optimal values, such optimal values may be, but are not limited to, data compiled by the United States Department of Agriculture (USDA); the National Academy of Sciences; The National Academy of Engineering; The Institute of Medicine of the National Academies; The Textbook of Functional Medicine; Clinical Nutrition, A Functional Approach and individual professional health care providers is accessed and used. The database, including detailed nutrient values shown for the foods consumed by the subject, will interface with a database including detailed nutrient information and an electronic report will be produced. Such report advises the subject of the detailed nutritive values derived from the subject's food data input and the report will further advise the subject of any possible nutritional deficiencies based upon given values. Such given values include, but are not limited to the USDA DRI (Daily Recommended Intake) of specific nutrients, recommended caloric intake based on weight, height, age, gender and physical activity level and recommended values such as, but not limited to, amounts of protein, carbohydrates, fat, cholesterol, sodium and fiber.

The nutritional analysis system and method of the present invention will generate a report of possible future health outcomes such as degenerative disease probabilities based on the subject's food data inputs. Such a report will be based upon a comparison of the subject's food data input and the databases compiled by, but not limited to, the United States Department of Agriculture (USDA); the National Academy of Sciences; The National Academy of Engineering; The Institute of Medicine of the National Academies; The Textbook of Functional Medicine; Clinical Nutrition, A Functional Approach and individual professional health care providers. The health monitoring system and method of the present invention will further allow a subject to receive a generated report based upon alterations to the personal food input data, so as to arrive at improved dietary choices that will project a more desirable, positive probable future health outcome. For example, if a subject consumes a diet of mostly simple carbohydrates and unhealthy fats and minimal fruits and vegetables during the time frame analyzed, then a report of probable poor health and degenerative disease such as, but not limited to, Type II diabetes will be generated. If the subject alters the food inputs to add missing nutrients suggested by the deficiency report such as increased fruits and vegetables, reduced carbohydrates and healthy fats, such as, but not limited to, omega 3 fats, then a report will be generated that will suggest a better possible health outcome.

### BRIEF DESCRIPTION OF THE DRAWINGS

These and other features and advantages of the present invention will be better understood by reading the following detailed description, taken together with the drawings wherein:

FIG. 1 is a flow chart of acts taken according to one aspect of the invention; and

FIG. 2 is a flow chart of the method according to the present invention.

### DETAILED DESCRIPTION OF THE PREFERRED EMBODIMENTS

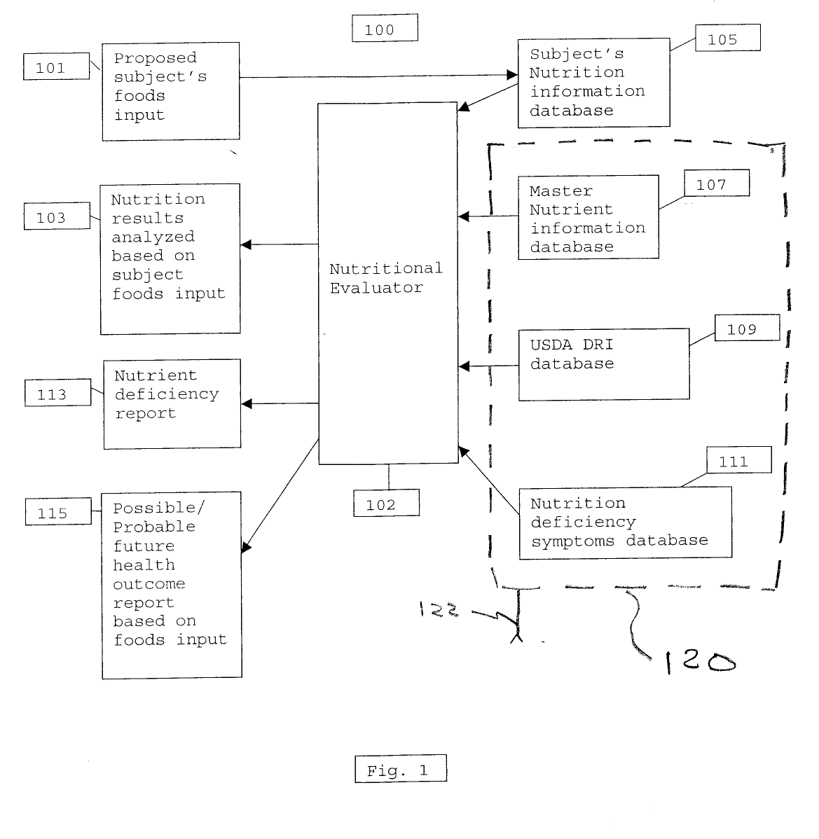

FIG. 1 illustrates a method and system 100 according to the present invention. Descriptions, quantity, etc. of foods eaten along with various personal factors such as, but not limited to, age, gender, physical activity level, height and weight are inputted, act 101, by an individual using an input device such as a computer, cell phone, PDA or the like, and stored into a database, 105. A nutrition analysis is performed by nutritional evaluator 102 based on the nutrition information input by the user 101 along with information stored in a master nutritional database 107 which stores detailed nutrient values compiled by various governmental and/or private organizations such as, for example only, the United States Department of Agriculture (USDA); the National Academy of Sciences; The National Academy of Engineering; The Institute of Medicine; The Textbook of Functional Medicine; and the reference book entitled Clinical Nutrition, A Functional Approach and individual professional health care providers.

Content for the Daily Recommended Intake (DRI) database 109 and a nutritional deficiency symptoms database 111 are received from one or more various sources such as, but not limited to, the Handbook of Signs and Symptoms published by Lippincott Williams & Wilkins, the Handbook of Diseases published by Lippincott Williams & Wilkins, the Textbook of Functional Medicine published by The Institute for Functional Medicine, Clinical Medicine, A Functional Approach published by The Institute for Functional Medicine, Food Chemistry 3^{rd} Revised Edition by H.-D. Belitz, W. Grosch and P. Schieberle and The Optimum Nutrition Bible by Patrick Holford.

Collectively, the master nutrient information database 107, the DRI database 109, and the nutritional deficiency symptoms database 111 comprise knowledge base 120 utilized by the system 100 of the present invention. In one embodiment, the knowledge base 120 is utilized by the nutritional evaluator 102 as will be described in greater detail below. In another embodiment of the present invention, the knowledge base 120 is independently searchable with access 122 by a user. For example, if a user is experiencing continued headaches, he or she may search the knowledge base 120 which will in fact be a search of the nutrition deficiency symptoms database 111 for occurrences of headache. This will allow the user to see what type of nutrients he or she might consume to help alleviate or at least reduce the user's headache symptoms. A user may also search by food types to determine what nutrients are in this food type. For example, if the user likes asparagus, he or she may search the knowledge base 124 the nutrients contained in asparagus. The user may also search for foods containing a particular nutrient. These examples are for illustrative purposes only and are not meant to be a limitation on either the data or search queries available to a system configured in accordance with the present invention.

The nutritional evaluator 102 is preferably appropriately programmed computer software operating on appropriate computer hardware, both designed to receive input and access stored information for performing the described evaluation.

The nutritional evaluator 102 utilizes as input the information from the various databases of information 105, 107, 109 and 111 and provides appropriate output reports 103, 113 and 115 in electronic or hard copy form. The nutrition results report information 103, which is a report of and the data related to an analysis of the various nutrients and other elements found in the foods input as eaten by the user (for example, if the user has input that they have eaten a medium sized banana, the nutritional evaluator 102 will output that the user has had access to certain specific nutrients that are contained in a banana) are then stored in the user's nutritional information database 105. The data from the user's nutritional information database 105 is compared with a master nutritional information database 107. The Daily Recommended Intake (DRI) information 109 for various food categories (fat, carbohydrates, vitamins, minerals, amino acids etc.) and compiled by the Institute of Medicine of The National Academies is accessed and used by the nutritional evaluator 102 to compile the master nutrient information database 107.

Information from a nutrient deficiency symptoms database 111 containing information related to diseases or illnesses generally caused by or linked to specific nutrient deficiencies such as for example, but not limited to, anemia, gout, bone pain, canker sores, diabetes, diarrhea, fatigue, low blood pressure, macular degeneration, poor night vision, etc., and compiled from one or more various sources such as, but not limited to, the Handbook of Signs and Symptoms published by Lippincott Williams & Wilkins, the Handbook of Diseases published by Lippincott Williams & Wilkins, the Textbook of Functional Medicine published by The Institute for Functional Medicine, Clinical Medicine, A Functional Approach published by The Institute for Functional Medicine, Food Chemistry 3^{rd} Revised Edition by H.-D. Belitz, W. Grosch, and P. Schieberle, The Optimum Nutrition Bible by Patrick Holford.

The nutritional evaluator 102 compares the information contained in the nutrient deficiency symptoms database 111 with the subject's nutritional information 105. A nutrient deficiency report 113 is then generated based on the comparison of the data from the nutrient deficiency symptoms database 111 and the user's nutritional information database 105, or any other appropriate data.

A possible, probable future health outcome report 115 is generated based on the data from nutrient deficiency symptoms database 111 and the user's nutritional information database 105 and any other appropriate data. For example, the probable future health outcome report 115 for a 35 year-old user may say that the user is likely to develop diabetes or other degenerative disease if he or she continues to eat, drink and not exercise as he or she is presently doing.

The nutritional evaluator 102 will also allow the user to enter new, revised food and beverage consumption information or new physical activity and perhaps weight information 101, to allow the user to immediately see, in report 115, how the revised eating, drinking, exercise and/or weight habits of a user might likely positively affect his or her health in the future. This immediate feedback is designed to serve as a motivator for a person to change his or her food choices and habits to live well and enjoy a more healthy life.

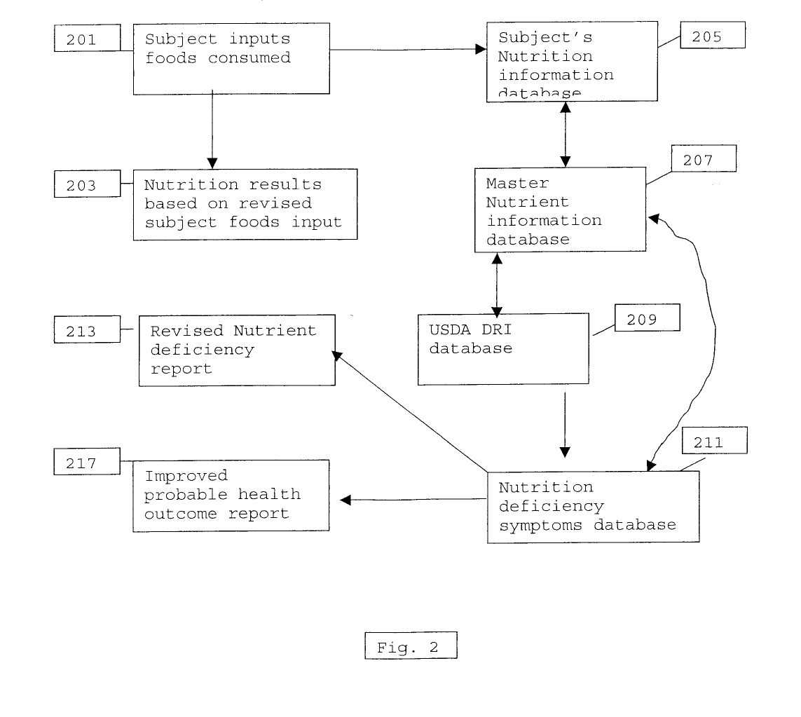

FIG. 2 is a flow chart illustrating the acts involved in operating the system of FIG. 1.

Reports can be generated at any point in the data collection and analysis steps. Such reports may be in electronic or paper format and those reports may be used in later analyses.

A user may enter many different combinations and amounts of foods into the data inputs of the present invention to try to generate increasingly better potential health outcomes. The nutritional analysis system and method of the present invention will allow the user to generate reports based upon alterations to their food input data so as to arrive at dietary choices that will project a more desirable probable future health outcome. In addition, the user may input changes to other parameters that he or she can vary such as weight and physical exercise, to view the projected and probable health results of such changes. Reports of the different outcomes may be produced at any time according to the system and method of the present invention.

Built into master nutritional information database 107 is a series of calculations based on the personal activity level information input by the user. For example: Total Calories Daily may be calculated for a Sedentary Lifestyle as desired weight×12, Moderately Active Lifestyle as desired weight×15 and Very Active Lifestyle as Desired weight×20-25. Protein is calculated as 12%-15% of calories; Carbohydrate may be calculated as 55%-58% of calories but less than 10% of calories from refined carbohydrates; fat may be calculated as less than 30% of calories but no more than 10% of calories from saturated fat; cholesterol may be calculated as under 300 milligrams daily; sodium may be calculated as 1110-3300 milligrams per day maximum and fiber may be calculated as 25-35 grams daily. Additionally, the DRI data 109 may be based on age and gender.

Modifications and substitutions by one of ordinary skill in the art are considered to be within the scope of the present invention, which is not to be limited except by the following claims.

What is claimed is:

1. A nutritional analysis system, comprising:
a user input receiver, for receiving input from a user, said input including one or more data inputs selected from the group consisting of: age, gender, height, weight, physical activity level, foods eaten, food quantity even, liquid consumed, and type of liquid consumed, said user input receiver configured for lease providing said data input to a use or nutritional information database; and
a nutritional evaluator, responsive to said user data input stored in said user or nutritional information database, and further responsive to a nutrient information database containing nutrient value information, a daily recommended intake database containing information concerning recommended daily intake of a plurality of nutritional elements, and a nutrition deficiency symptoms database containing information concerning diseases and/or illnesses caused by or linked to specific nutrient deficiencies, for providing at least one of a nutrient deficiency report, a probable future health outcome report and a nutrient value report.

2. The system of claim 1, wherein said user input is provided on a day by day basis.

3. The system of claim 2, wherein said nutritional evaluator provides said at least one of a nutrient deficiency report, a probable future health outcome report and a nutrient value report based on a user selectable period of time including a plurality of days of user input data.

4. The system of claim 1, wherein said plurality of nutritional elements are selected from the group consisting of amino acids, antioxidants, carbohydrates, fats, phytonutrients, proteins, minerals and vitamins.

5. The system of claim 1, wherein said nutrient value report provides an indication of the calculated value of certain food related elements in ingested or potentially ingested foods, said food related elements including at least one element selected from the group consisting of: calories, protein, carbohydrate, fat, cholesterol, vitamins, minerals, amino acids and sodium.

6. The system of claim 1, wherein said reports provided by said nutritional evaluator are provided electronically or in hard copy printed form.

7. The system of claim 5, wherein said nutrient evaluator provides said nutrient value report in response to user input data including ingested foods, age, gender, physical activity level, height and weight, and wherein said nutrient evaluator is further responsive to said daily recommended intake database containing information concerning recommended daily intake of a plurality of nutritional elements, for providing said nutrient deficiency report, said nutrient deficiency report outlining excess nutrient intake and a deficient nutrient intake.

8. The system of claim 7, wherein said nutrient evaluator provides information concerning bodily functions that said excess nutrient intake and a deficient nutrient intake will affect.

9. The system of claim 1, wherein said nutrient information database includes information concerning food sources for a plurality of nutrients.

10. The system of claim 1, wherein said user data input may be actual user data or proposed user data, and wherein utilizing said proposed user data, said nutritional evaluator will provide said user with a probable health report for potential changes which might be made by the user to the user's food choices, physical activity level and weight.

11. The system of claim 1, wherein the master nutrient information database, the daily recommended intake database and the nutritional deficiency symptoms database 111 collectively comprise a knowledge base, wherein the knowledge base is utilized by the nutritional evaluator and is independently searchable with access by a user.

12. A nutritional analysis system, comprising:
a searchable nutritional knowledge base comprising a nutrient information database containing nutrient value information, a daily recommended intake database containing information concerning recommended daily intake of a plurality of nutritional elements, and a nutrition deficiency symptoms database containing information concerning diseases and/or illnesses caused by or linked to specific nutrient deficiencies; and
means for allowing a user to access and search said searchable nutritional knowledge base, for allowing a user to search said knowledge base.
